(19) United States
(12) Patent Application Publication
(10) Pub. No.: US 2011/0279245 A1
(43) Pub. Date: Nov. 17, 2011

(54) SYSTEM AND METHOD FOR ASSOCIATING RFID SMART LABELS WITH CUSTOMER DATABASE RECORDS FOR USE WITH AUTOMATED TRACKING OF WASTE AND RECYCLABLE MATERIAL

(75) Inventors: Eamon Hynes, Limerick (IE); James Martin, Limerick (IE)

(73) Assignee: Advanced Manufacturing Control Systems Ltd., Limerick (IE)

(21) Appl. No.: 12/779,497

(22) Filed: May 13, 2010

(51) Int. Cl. H04Q 5/22; H04N 1/00

(52) U.S. Cl. 340/10.42; 358/1.6

(57) ABSTRACT

A method of quickly and accurately associating a customer name and address with a unique RFID identification tag to be used on a waste or recyclable materials container by the customer. A self-adhesive RFID label including an embedded RFID identification tag is provided in an envelope. Using a hand-held RFID tag reader or more preferably, an RFID reader mounted in a printer coupled to a computer device, a customer name and address is selected from a database and printed on an envelope or directly on the RFID label. Using the RFID reader in the printer and while the customer name and address is being printed, the unique RFID identification number from the RFID identification tag is read, provided to the computer device and automatically inserted into the customer database record, thereby associating the unique RFID identification tag number with the customer record. The RFID label is then delivered (mailed) to or picked up by the customer, all without need to send someone to a customer site to read the RFID tag associated with a waste or recycle bin and associated with the customer record. The customer can then easily apply the self-adhesive label with the RFID tag to their appropriate waste or recycle container.

### TECHNICAL FIELD

The present invention relates to tracking materials picked up at a customer location and more particularly, relates to a system and method for automatically associating a customer from a customer database with a unique identifier device to be placed on the waste or recyclable material container.

### BACKGROUND INFORMATION

Residential consumers generate a large amount of waste and recyclable materials that must be disposed of on a periodic basis. In more urban settings, municipalities or private service providers will generally come to residential and/or business locations and pickup waste and/or recyclable materials at curbside.

In the past, identifying these materials and their quantity was not an issue. More recently, however, many municipalities have begun charging for waste pickup based on the quantity of waste material, or have instituted forced recycling programs sometimes adding an incentive for recycling. In the case of charging for waste pickup, some municipalities have begun accepting only certain types or colors of waste refuse bags and sell these bags thereby creating a Pay-for-disposal waste program.

Radio Frequency Identification (RFID) is an identification management technology that uses radio waves to enable short-range wireless identification and tracking. RFID uses a tag or transponder that is embedded into, or applied to a product or person. RFID tags are like intelligent bar codes. They consist of a microchip combined with an antenna in a compact package. The tag antenna receives electromagnetic energy output from the antenna of an RFID reader. Passive tags use the power from the reader to send radio waves back to the reader. Active tags use an internal power source. The reader receives, and then interprets, the tag data and can pass this data through standard interfaces to a host computer or programmable logic controller for processing. The RFID tag can have a read distance up to several meters. An RFID tag has a unique identification number preprogrammed during manufacture. Additional data can be written to and read from the RFID tag.

One of the emerging RFID applications is in waste management. RFID technology can be used by municipalities and private waste collectors in a variety of ways to improve the efficiency of the waste operation. Examples of waste management RFID applications include incentive based recycling schemes and new waste collection cost models.

RFID technology can enable the deployment of incentive based recycling schemes. One example is the city of Philadelphia's RecycleBank®. Each resident receives a waste bin, which has been fitted with an RFID tag to identify the associated household. Recycling waste trucks are fitted with RFID readers and weighing capability. As each RFID tagged bin is lifted by the waste truck, the household is identified from the RFID tag fitted to the bin and associated with a customer in a customer database, the bin is weighed, and the data is logged to the RecycleBank® database. RecycleBank® can track the recycle weight per household per month and the household receives discount coupons that can be redeemed at predetermined retailers based on the recycle weight.

RFID technology can also enable new waste collection cost models. Instead of imposing a flat yearly fee for the waste collection service or selling waste bags, a Pay-As-You Throw (PAYT) program can be developed where households pay a variable rate depending on the amount of waste (weight) they produce or recycle. The PAYT program can bill customers each time their waste bin is emptied, debit a prepayment account or by combining bin identification and bin weighing technology, the customer can be billed based on total waste weight.

Waste management systems that utilize RFID technology are known in the art. The systems typically include:
1. Central office: The central waste management office includes the central computer which manages the waste system, the customer database to cross reference customer details with waste bin RFID identification number and the wireless communication system to communicate with mobile waste trucks.
2. Mobile waste truck: The mobile waste truck includes an RFID reader to read the waste bin RFID identification number, wireless communication system to communicate with central computer, GPS device to identify truck location co ordinates, waste bin weigh capability, clock and display interface for truck driver.
3. Customer RFID enabled waste bin: The customer waste/recycle bin has an RFID tag with a unique identification number. This identification number is associated with the customer details saved in the customer database at the central office.

Waste and recycling containers that incorporate RFID tags are well known in the art. The RFID tag can be embedded during the bin manufacturing process or subsequently inserted into a cavity on the bin or affixed to the bin, as disclosed in U.S. Pat. No. 6,191,691 incorporated herein by reference.

A customer database is needed to associate each RFID enabled bin via either an RFID tag or RFID Smart label with the customer household. This database is stored on a computer at the waste company central office. When a waste truck starts a new bin collection route, at least a portion of the database is downloaded from the central office computer to the waste truck computer via a wireless communication link. This portion of the database contains the customer details and RFID tag unique identification number for the waste bin collection route for that particular truck for that particular day. This means that the waste truck computer has enough information to complete the waste collection route, however, the waste truck is in regular communication with the central computer via wireless communication link to enable active updating of the database.

As the waste truck lifts each bin, the RFID tag number is read. The database on the truck can cross reference the RFID tag number with the customer household identity. This verification information may be flashed to a driver display screen. The waste collection information associated with the bin lift such as bin weight can be saved to the waste truck computer, additional information such as the time and the GPS co-ordinates of the truck may also be saved. The waste collection information can be transmitted to the central back office computer via the wireless communication link.

A waste management company may have a fleet of 20 trucks. Each truck may lift 1000 waste containers each day; hence the total number of waste containers in the waste company account can easily exceed 100,000. Each of the waste containers must have an RFID tag fitted and the RFID tag identification number needs to be associated with the customer household details in a central database prior to the collection of waste or recyclable materials. Creating this association is a huge infrastructural task and is one of and perhaps THE limiting factor on the pace of deployment of RFID waste and recyclable material collection technology. Additionally, this infrastructural task remains a large maintenance overhead to add new customers and keep the customer database up to date.

Presently there is no automated method of associating waste or recyclable material container RFID tags with specific customers and their waste/recycling bin, and for populating the waste/recyclable customer cross reference database with the RFID tag information.

Current methods used by the waste industry are prone to error, are slow and quite labor intensive. The association task in the prior art can be broken down into a number of steps, these include:
1. Identify waste bin at customer location;
2. Fit RFID tag;
3. Read RFID tag unique identification number;
4. Create association of RFID identification number and customer details; and
5. Transmit data back to central computer to save to a customer database.

In order to carry out the steps, the prior art requires that someone from the waste company be sent to the customer site to try to identify a customer's bin, which can be problematic if the customer is not at home or there are multiple bins in the same area. Next, an RFID tag has to be fitted to the bin. This is sometimes difficult and cumbersome and may even require tools to screw or rivet the RFID tag to the waste bin. Many individuals cannot perform this task and the waste company often undertakes this task.

Accordingly, the waste company must travel to the customer address and locate the waste bin. If the waste bin does not already have an RFID device, then the RFID device must be fitted to the bin. The RFID tag can be locked to ensure that it cannot be subsequently over-written or its data changed. The only information stored on/by the RFID tag is the unique identification number. This means that the customer database which is securely located at the waste company central office, is fundamental to the customer identification. A commercially available hand held RFID reader connected to a mobile computer can be used to read and store the RFID identification number. Once back at the central office, the relationship between the RFID tag identification number and customer address/identification must now be established.

In use, additional information such as pickup date field, product field (waste, paper recycle, class recycle, plastic recycle or the like and weight field will be added. This information can be transmitted by wireless communication link to a central back office computer to populate the customer database. This prior art process must be repeated at every customer household location. This limits the rate of deployment of waste technology to new customers and in some instances may even force communities to abandon the thoughts of the deployment of that technology. In a rural area, the database population rate can be as low as <100 bins per day.

Accordingly, what is needed is a system and method for relating or associating an RFID tag and identification number with the customer RFID enabled waste or recycle bin identification and customer specific information in a central database and not in the field, prior to having the customer physically place the RFID tag, in the form of an adhesive label, on their own bin.

### SUMMARY OF THE INVENTION

The present invention relates to an automated method of associating customer RFID enabled waste bin identification information with customer specific information in a central database in the central office without having to send a worker or technician into the field, and prior to the RFID enabled identification information being applied to the waste or recyclable bin at the customer site.

The present invention takes advantage of ‘smart label’ RFID technology. ‘Smart labels’ represent the next generation of RFID tags and are well known in the industry. They have an RFID tag embedded within the label substrate material. Certain such RFID labels are adapted to withstand the harsh waste environment. This RFID label technology enables RFID tag installation on a waste container to become a simple customer task by attachment of a sticky label to the outer bin surface. The instructions for label application may even be written on the peel-off back of the RFID label itself. These instructions may include instructions on the appropriate location of the RFID label on the waste bin.

The present invention is directed to a method of quickly and accurately associating a customer name and address with a unique RFID identification tag to be used on a waste or recyclable materials container by the customer. A self-adhesive RFID label including an embedded RFID identification tag is provided in an envelope. Using a hand-held RFID tag reader or more preferably, an RFID reader mounted in a printer coupled to a computer device, a customer name and address is selected from a database and printed on an envelope or directly on the RFID label. Using the RFID reader in the printer and while the customer name and address is being printed, the unique RFID identification number from the RFID identification tag is read, provided to the computer device and automatically inserted into the customer database record, thereby associating the unique RFID identification tag number with the customer record. The RFID label is then delivered (mailed) to or picked up by the customer, all without need to send someone to a customer site to read the RFID tag associated with a waste or recycle bin and associated with the customer record. The customer can then easily apply the self-adhesive label with the RFID tag to their appropriate waste or recycle container.

The method comprises the acts of:
1. first selecting at least a first customer name and address from a customer database on a computer device;
2. Using an automated RFID reader coupled to the computer device, the method next includes automatically reading a yet unknown RFID unique identifier from an RFID identification tag;
3. Using the computer device, the method next includes automatically receiving the read RFID unique identifier from the RFID tag;
4. using the computer device, the method next automatically inserts the read RFID unique identifier from the RFID tag into the database in association with the at least a first customer name and address, to thereby create a customer specific data record;
5. lastly, the method next saves the customer specific data record (now including the associated RFID tag number) in the customer database.

In the preferred embodiment, the RFID identification tag is part of a self-adhesive label. The self-adhesive label may be located in an envelope. The automated RFID reader coupled to the computer device preferably includes a printer into which has been inserted a plurality of envelopes, each envelope containing one of the self-adhesive labels including an RFID identification tag. The printer is configured for printing, either directly on the envelopes or on a sheet of paper to be inserted in a “window” in the envelope, and at least in human readable format, a customer name and address, and for reading the yet unknown RFID identifier from the RFID identification containing self-adhesive label disposed in the envelope, and for providing the RFID identifier to the computer device. The self-adhesive label is configured for use on a waste or recyclable materials container. In the preferred embodiment, the label with the RFID tag having the RFID unique identifier is provided to the customer. The RFID tag with the RFID unique identifier from the RFID tag is preferably part of a self-adhesive label disposed in a mailing envelope, and wherein the mailing envelope is provided to the customer by mail. In this manner, the customer may identify and select his or her container and apply the label including the RFID tag without intervention from the waste or recycling company employee.

The act of selecting at least a first customer name and address from a customer database includes first entering at least a first customer name and address into the customer database. The method may also include printing a barcode on the envelope, the bar code encoding the customer name and address of the customer name and address being printed in human readable form on the envelope.

The act of entering the at least a first customer name and address into the customer database may include reading a barcode printed on the envelope in which at least the first customer name and address has been encoded. Reading the yet unknown unique identifier from the RFID tag may include automatically reading the yet unknown unique identifier using an RFID reader. The RFID reader may be built into a printer, and wherein the RFID tag may be located in an envelope being generally simultaneously printed upon by the printer. The RFID reader may be a handheld reader.

The method may include printing at least the customer address on the RFID label and subsequently inserting the RFID label bearing at least the customer address into a windowed envelope, wherein the windowed envelope is configured for mailing the RFID label to the customer address. Printing at least the customer address on the RFID label may include printing the customer name and address on the RFID label.

### BRIEF DESCRIPTION OF THE DRAWINGS

These and other features and advantages of the present invention will be better understood by reading the following detailed description, taken together with the drawings wherein:

FIG. 1 is a schematic block diagram of the system for automated tracking of waste and recyclable material according to the present invention; and

FIG. 2 is a schematic diagram of a database record used in the system of the present invention.

### DETAILED DESCRIPTION OF THE PREFERRED EMBODIMENTS

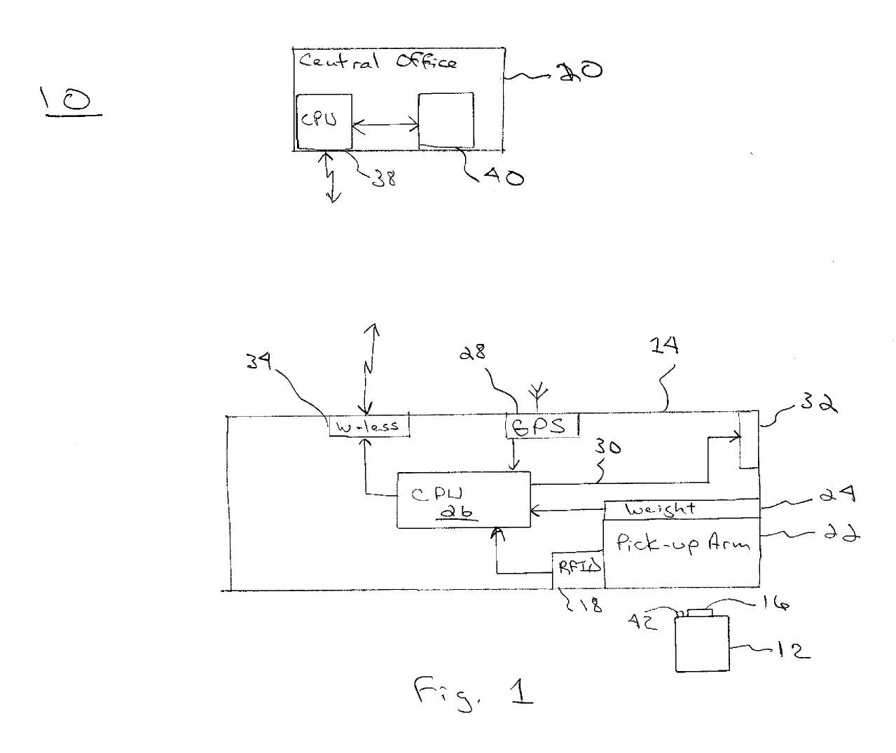

The present invention relates to a system and method for relating or associating a customer RFID enabled waste bin identification information with customer specific information at the waste company central office and not in the field. The present invention is operated in connection with a system 10, FIG. 1, implementing an automated tracking of waste and recyclable material. The system includes 3 major components: a trash or recyclables container 12 located in front of a residence or business; a mobile truck and pick-up vehicle 14 and a central office 20.

The container 12 may be any type of container which is configured or lends itself to automated pickup using a pickup arm or the like controlled by an operator operating a truck-like pickup vehicle 14 which is described in greater detail below. Such containers are well-known in the industry to those of ordinary skill in the art.

The container 12 includes a radio-frequency identification (RFID) tag 16 or other similar automated readable device or label, such as an RFID containing smart label, which can be read by an RFID reader 18 or the like located on the truck 14. The RFID tag 16 contains a unique identification number. This identification number is associated with the customer details saved in the customer database 40 at the central office 20. The identification tag 16 serves to tell the waste or recycling collection system to which homeowner or business the container presently being picked up is associated with, so that proper charges or credit may be allocated to the right customer as will be explained in greater detail below.

The mobile truck 14 includes a container pickup arm 22 as is well known in the industry and described, for example, in U.S. Pat. No. 5,470,187 incorporated herein by reference. Coupled to the pickup arm 22 may be a weighing mechanism or scale 24 that provides the weight of the container 12 being picked up prior to the container's contents being dumped into a holding area (not shown) in the truck 14. The weight of the container 12 is provided to a central processing/data storage unit 26 located on the truck 14. The weight of the container 12 can be adjusted either by the weighing mechanism or scale 24 or the central processing/data storage unit 26 to account for the actual weight of the empty container itself. This adjustment can be performed by subtracting the nominal weight of a container from the measured weight of the full container. Alternatively, the container may be weighed full and empty and a subtraction used as the weight of the waste or recyclable materials picked up.

Truck 14 also preferably includes a GPS unit 28 that is utilized to help determine or confirm the location of the truck 14 and the container 12. In operation, the GPS unit 28 may send an address signal 3 to a display 32 positioned to be read by the driver of the truck 14. In this manner, the GPS unit 28 may alert the driver to the fact that he or she is presently at a certain address that the driver can confirm visually as well as from knowledge of the route. This information can be used to corroborate against the customer identification information retrieved from automatically reading the RFID tag 16 on the container 12.

The mobile truck 14 may also include a wireless signal transmitter and receiver 34 which serves to periodically, or in batch mode, transmit information about picked up waste or recyclable materials to the central office 20. A wireless receiver and a central processor 38 at the central office 20 receive the information transmitted. The received information is organized and stored in a central customer database 40.

Thus, as the waste truck 14 lifts each container 12, the RFID tag number 16 is read. The database on the truck CPU 26 can cross-reference the RFID tag number to a customer household identity. This verification information may be flashed to a driver display screen 32. The waste collection information associated with the bin lift such as bin weight can be saved to the waste truck computer 26, additional information such as the time and the GPS co-ordinates of the truck may also be saved. The waste collection information can then be transmitted to the central office computer 38 via the wireless communication link 34.

Accordingly, the present invention enables the creation of the customer/RFID tag association database in the waste company office rather than in the field. This gives the advantage of a computer-automated process with efficiencies in time, labor, and accuracy yielding increased deployment of the technology.

As previously mentioned, the present invention takes advantage of ‘smart label’ RFID technology. ‘Smart labels’ represent the next generation of RFID tags and are well known in the industry. They have an RFID tag embedded within the label substrate material. RFID labels adapted to withstand the harsh waste environment are known in the art. RFID label technology enables RFID tag installation on a waste container to become a simple customer task by attachment of a sticky label to the outer bin surface. The instructions for label application may even be written on the peel-off back of the RFID label itself. These instructions may include use of an alcohol wipe to clean the bin surface prior to application and also instruction on the appropriate location of the RFID label on the waste bin.

In one embodiment of the invention, the RFID label may be applied to a waste bin at the waste company office where the user may go and pick up an entire bin with an RFID tag already applied. In this method, a waste company employee can use a handheld RFID tag reader to scan the RFID tag identification number that is automatically inserted into a database that the employee completes with the customer's name and address and other pertinent information. The Smart labels also lend themselves to being placed in an envelope which can later be addressed and have the RFID identification device scanned while in the envelope and associated with a customer database record all prior to the label being sent or given to a consumer.

In the preferred embodiment of the present RFID association method, the method starts with providing a number of randomly selected RFID labels; each label already inserted into one mailing type envelope. It is not necessary for the envelope to identify the RFID information. The envelopes loaded with RFID labels are placed in a tray or bin in a printer that is coupled to a customer database and capable of not only printing on the envelope but also includes a reader that can read the RFID tag information included in the “Smart label” already placed within the envelope.

The preferred embodiment of the invention uses a commercially available RFID read or read/write enabled label printer connected to a computer and located in the waste company office. Such RFID read and/or write enabled label printers are available, for example, from DataMax Corporation of Orlando Fla. The computer to which the printer is connected has access to the customer database 40.

A single RFID label and customer label application instructions are inserted into individual envelopes. The envelopes are then fed to the printer. The new customer details (previously or presently entered into the database) are selected from the database. The address of the new customer is printed on the envelope for mailing/identification purposes. The RFID read enabled printer then “reads” the RFID label's unique identification number contained inside the envelope.

The association of customer details (name and address) from the current database entry and the unique RFID identification number read from the RFID tag contained on the Smart label inside the envelope can be completed by saving the RFID unique identification number data to the open customer database record 50. The envelope containing the RFID label can then be mailed to or picked up by the customer who will attach the label to their appropriate been to complete the task.

This automated process enables the deployment of waste technology to new customers at a rate that is only limited by the printer speed. The data base population rate increases to >100 bins per hour. In addition to improved efficiency of time and labor, the automated process ensures accuracy and security of the customer database.

In a variant on the method described above, the invention may make use of UHF operating frequency RFID tag on a smart label having either no unique identification number or a factory written identification number that can be overwritten and the RFID tag thereafter “locked” to prevent the unique Id from being changed. UHF RFID tags are a type of RFID tag. RFID tags can have different operating frequencies—LF, HF, UHF, microwave and will have different read ranges, transfer rates. There is no change to the function of the tag. In addition, RFID tags can be “read-only” where the factory defined unique identifier number is permanently stored on the tag, or an RFID tag can be “read/write” enabled where a user can change the ID (to a customer specific ID) and add additional data to the tag memory.

In this embodiment, the method utilizes a read/write printer. The smart label is inserted into the read/write printer and a unique identifier is assigned to the customer. The unique identifier is written to the RFID tag either overwriting any previously written number or written to the tag for the first time. The RFID tag is then “locked” so that the unique ID cannot be thereafter changed or overwritten by the user or some third party, as is well known in the art. Next, the unique identification number assigned and just written to the RFID tag is associated with the customer and inserted into the database as described above.

In another embodiment, the invention may make use of read/write enabled RFID tags that are shipped from the factory without a unique identifier ID but containing a default ID that must be modified at the customer site. Rather than writing a unique customer specific ID as an additional part of the customer association task, the RFID tags may be assigned a unique RFID identifier as part of a separate write/read operation performed in advance of the customer association step. The RFID tag ID can then be read as part of the customer association task as described above.

Another embodiment of the invention removes the need for an RFID read/write enabled printer. In this embodiment, a standard commercial printer can be used. New customer addresses may be printed on envelopes both in human readable and in bar code form. RFID labels and customer application instructions are inserted into the addressed envelopes. A hand held reader can then be used to read the RFID identification number on the RFID label contained inside the envelope and then read the customer address barcode. The association of customer details and RFID identification number can be completed by saving the database record 50 to the customer database 40. The RFID label can then be mailed or hand delivered to the customer address or picked up by the customer.

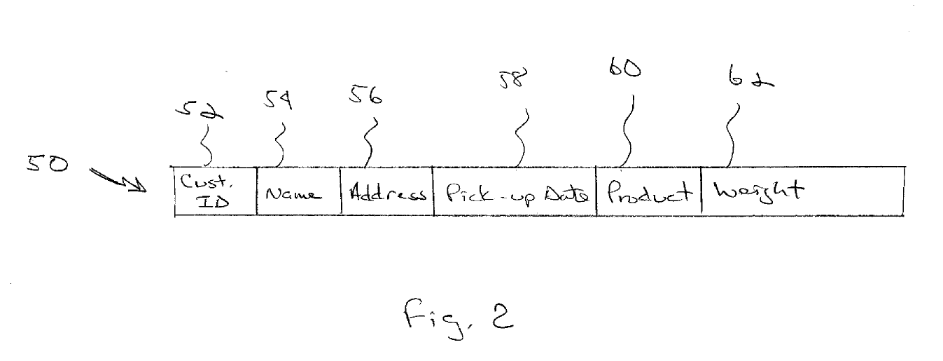

For example, one entry 50, FIG. 2, in the customer database 40 illustrates the RFID tag number field 52 assigned to the customer, along with a customer name field 54, and customer address field 56. Other fields in the customer database record are contemplated and this example is for illustrative purposes only.

Another embodiment of the invention removes the need for RFID read capability and is the lowest cost solution. The RFID label can have the RFID identification number printed on it in bar code form. New customer addresses may be printed on envelopes or on pieces of paper to be inserted in clear “windows” in the envelope both in human readable and/or in bar code form. A bar code only reader can be used to scan the bar coded customer address on the outside of the envelope and then scan the RFID label identification bar coded number before inserting the RFID label completely into the addressed envelope. The association of customer details and RFID identification number can be completed by saving the scanned bar coded data to the customer database. The RFID label can then be mailed or otherwise provided to the customer address. Once the customer receives his or her RFID label, the customer can identify or locate his or her waste or recycle container and apply their RFID label directly to that container.

In another embodiment, the RFID label may include customer name and/or address. Although in the prior embodiments the RFID label did not have any identifier information linking the label with the customer which is useful in some instances for customer privacy reasons, in other instances, the customer may wish to have their name on the label to identify their bin (for example, where multiple bins are stored in a common area).

In this embodiment, RFID labels can be provided to the RFID printer either in single form, stacked form or in spool form. Once the customer is selected, the customer name and/or address can be printed directly on the RFID label as the RFID unique identifier from the RFID tag on the label is being read. The association of the RFID tag and customer information is established in the database. The label bearing the customer name and/or address can subsequently be mailed to the customer by simply inserting the label into a “windowed” envelope.

Accordingly, the present invention provides a more automated method to quickly and accurately associate customer name and address information with a unique RFID identification tag that will be attached to a waste or recyclable materials container to be used by that customer. This method does not require the use of time-consuming and costly customer site visits.

The present invention is not intended to be limited to a device or method which must satisfy one or more of any stated or implied objects or features of the invention and should not be limited to the preferred, exemplary, or primary embodiment(s) described herein. Modifications and substitutions by one of ordinary skill in the art are considered to be within the scope of the present invention, which is not to be limited except by the allowed claims and their legal equivalents.

The invention claimed is:

1. A method of automatically associating customer information with a unique identifier from an RFID identification tag, the method comprising the acts of:
selecting at least a first customer name and address from a customer database on a computer device;
using an automated RFID reader coupled to said computer device, automatically reading a yet unknown RFID unique identifier from an RFID identification tag;
using said computer device, automatically receiving said read RFID unique identifier from said RFID tag;
using said computer device, automatically inserting said read RFID unique identifier from said RFID tag into said database in association with said at least a first customer name and address to create a customer specific data record; and
saving said customer specific data record in said customer database.

2. The method of claim 1, further including after the act of saving said customer specific data record in said customer database, performing the act of providing said RFID tag with said RFID unique identifier from said RFID tag to said customer.

3. The method of claim 2, wherein said RFID tag with said RFID unique identifier from said RFID tag is part of a self-adhesive label disposed in a mailing envelope, and wherein said mailing envelope is provided to said customer by mail.

4. The method of claim 1, wherein said RFID identification tag is part of a self-adhesive label.

5. The method of claim 4, wherein said self-adhesive label is disposed in an envelope.

6. The method of claim 3, wherein said automated RFID reader coupled to said computer device includes a printer into which has been inserted a plurality of said envelopes, each envelope containing one of said self-adhesive labels including an RFID identification tag, and wherein said printer is configured for printing, on one of said envelopes and at least in human readable format, a customer name and address, and for reading said yet unknown RFID identifier from said RFID identification containing self-adhesive label disposed in said envelope, and for providing said RFID identifier to said computer device.

7. The method of claim 1, wherein said act of selecting at least a first customer name and address from a customer database includes entering at least a first customer name and address into said customer database.

8. The method of claim 6, further including the act of printing a barcode on said envelope, said bar code encoding said customer name and address of said at least a first customer name and address being printed in human readable form on said envelope.

9. The method of claim 7, wherein said act of entering said at least a first customer name and address into said customer database includes reading a barcode printed on said envelope in which at least said first customer name and address has been encoded.

10. The method of claim 1, wherein said act of automatically reading said yet unknown unique identifier from said RFID tag includes automatically reading said yet unknown unique identifier using an RFID reader.

11. The method of claim 1, wherein said act of automatically reading said yet unknown unique identifier from said RFID tag includes automatically reading said yet unknown unique identifier using an RFID reader built into a printer, and wherein said RFID tag is disposed in an envelope being generally simultaneously printed upon by said printer.

12. The method of claim 4 wherein said self-adhesive label is configured for use on a waste or recyclable materials container.

13. The method of claim 1, further including the act of printing at least said customer address on said RFID label and subsequently inserting said RFID label bearing at least said customer address into a windowed envelope, wherein said windowed envelope is configured for mailing said RFID label to said customer address.

14. The method of claim 13, wherein said act of printing at least said customer address on said RFID label includes printing said customer name and address on said RFID label.

15. A method of automatically associating customer information with a unique identifier from an RFID identification tag, the method comprising the acts of:
selecting at least a first customer name and address from a customer database on a computer device;
using an automated RFID reader coupled to said computer device, automatically reading a yet unknown RFID unique identifier from an RFID identification tag, wherein said RFID identification tag is part of a self-adhesive label disposed in an envelope, wherein said automated RFID reader coupled to said computer device includes a printer into which has been inserted a plurality of said envelopes, each envelope containing one of said self-adhesive labels including an RFID identification tag, and wherein said printer is configured for printing, on one of said envelopes and at least in human readable format, a customer name and address, and wherein said printer is further configured for reading said yet unknown RFID identifier from said RFID identification containing self-adhesive label disposed in said envelope in said printer, and for providing said RFID identifier to said computer device;
using said computer device, automatically receiving said read RFID unique identifier from said RFID tag;
using said computer device, automatically inserting said read RFID unique identifier from said RFID tag into said database in association with said at least a first customer name and address to create a customer specific data record; and
saving said customer specific data record in said customer database; and
providing said RFID tag with said RFID unique identifier from said RFID tag to said customer.

16. A method of automatically associating customer information with a unique customer identifier assigned to an RFID identification tag, the method comprising the acts of:
selecting at least a first customer name and address from a customer database on a computer device;
said computer device assigning a unique identifier to be associated with said first customer name and address;
using an RFID writer device coupled to said computer device, automatically writing said computer device assigned unique identifier to an RFID identification tag inserted in said RFID writer device, and subsequently using said RFID writer device to lock said RFID identification tag so as to prevent said assigned unique identifier written to said RFID tag from being changed;
using said computer device, automatically inserting said assigned unique identifier to be associated with said first customer name and address into said database in association with said at least a first customer name and address to create a customer specific data record; and
saving said customer specific data record in said customer database.
